(19) United States
(12) Patent Application Publication
(10) Pub. No.: US 2015/0242496 A1
(43) Pub. Date: Aug. 27, 2015

(54) LOCAL CONTENT FILTERING

(71) Applicant: Microsoft Corporation, Redmond, WA (US)

(72) Inventors: Benny Schlesinger, Ramat Hasharon (IL); Saar Yahalom, Tel Aviv (IL); Ghila Castelnuovo, Tel Aviv (IL); Blaise Aguera y Arcas, Seattle, WA (US)

(73) Assignee: Microsoft Corporation, Redmond, WA (US)

(21) Appl. No.: 14/186,806

(22) Filed: Feb. 21, 2014

(51) Int. Cl. G06F 17/30; G06Q 50/26; H04L 12/18

(52) U.S. Cl. CPC G06F 17/30699; H04L 12/1813; G06Q 50/265

(57) ABSTRACT

One or more techniques and/or systems are provided for locally filtering content on a device, which preserves privacy of a user (e.g., user specific data is not sent from the device to obtain content tailored to the user). A set of content candidates may be retrieved from a remote source (e.g., a restaurant app may retrieve menu items from a restaurant server). A user personalization profile may be used to locally filter the set of content candidates to generate a filtered set of content. For example, the user personalization profile may indicate that the user maintains a low-carb diet and that the user prefers expensive Asian restaurants (e.g., based upon a low-carb diet document saved on the user's device and/or device locational information indicating the user frequents expensive Asian restaurants). In this way, the restaurant app may display the filtered set of content (e.g., expensive Asian restaurants serving low-carb food).

### BACKGROUND

Many users may access content from remote sources. In an example, a user may utilize a web browser and/or a search app on a device to access a search engine website hosted by a search server. In another example, a restaurant app on the device may access a map server to obtain local restaurant and/or menu information. When accessing remote sources, the device may send personal information to remote sources so that the remote sources may send personalized content to the device. However, the user may not want to share such personal information with remote sources and/or other entities that may listen across communication lines.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for local filtering of content are provided herein. For example, a user personalization profile may be generated for a user based upon a user context (e.g., gender, location, an activity engaged in by the user, etc.) and/or user data (e.g., a calendar, an email, a document, a coupon, a search history, a social network post, an image, a subscription to a service, etc.). The user personalization profile may be locally maintained on a device associated with the user. The user personalization profile may be used to locally filter content at the device. It may be appreciated that the user may opt-out or opt-in for generation and/or utilization of the user personalization profile (e.g., the user may request to have content personalized on the device).

In an example, the device may retrieve a set of content candidates from a remote source (e.g., a web browser may retrieve a set of search results; a recommendation app may retrieve a set of recommendations; a restaurant app may retrieve a menu; a shopping app may retrieve merchandise; etc.). The user personalization profile may be used to locally filter the set of content candidates on the device to generate a filtered set of content. For example, a set of menu items may be filtered based upon a medical condition and/or a diet specified by the user personalization profile (e.g., the user may have posted the diet to a social network, the user may have medical records on the device, etc.). In this way, personalization filtering may be locally performed on a device regardless of whether the device is connected to the remote source or a network. Because personalization filtering is locally performed on the device, security and privacy may be improved because personal information is not sent to the remote source for remote filtering.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of local filtering of content.

FIG. 2 is a component block diagram illustrating an exemplary system for generating a user personalization profile.

FIG. 3A is a component block diagram illustrating an exemplary system for locally filtering a set of content candidates for storage as a filtered set of content.

FIG. 3B is a component block diagram illustrating an exemplary system for providing recommendations through a device based upon a filtered set of content.

FIG. 4 is a component block diagram illustrating an exemplary system for providing locally filtered content.

FIG. 5 is a component block diagram illustrating an exemplary system for providing locally filtered content.

FIG. 6 is a component block diagram illustrating an exemplary system for providing locally filtered content.

FIG. 7 is a component block diagram illustrating an exemplary system for adding filtering functionality to a device.

FIG. 8 is an illustration of an exemplary computer readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for local filtering of content are provided. For example, a device may retrieve content from a remote source (e.g., a news app may retrieve news content). Instead of providing personal information about the user to the remote source for remote filtering that may otherwise result in unwanted exposure of private information, a user personalization profile may be used to locally filter the content at the device (e.g., the news app may filter the news content based upon a political view of the user, sports interests of the user, and/or other personal information of the user). In this way, content may be locally filtered online and/or offline to mitigate exposure of personal information.

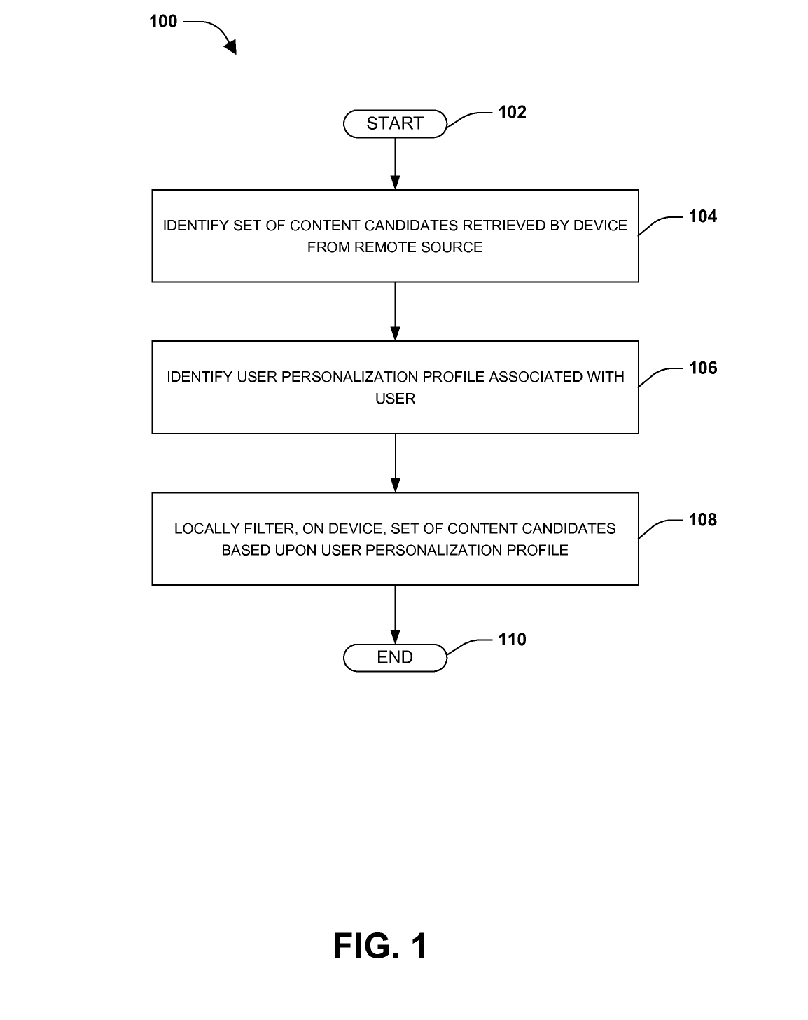

An embodiment of local filtering of content is illustrated by an exemplary method 100 of FIG. 1. At 102, the method starts. In an example, a user personalization profile for a user of a device may be generated based upon a user context and/or user data. The user personalization profile may describe various aspects of the user that may be used to provide personally tailored content to the user. In an example, the user personalization profile may be generated based upon a user context, such as a device location, a gender of the user, a current event attended or to be attended by the user, a meeting attended or to be attended by the user (e.g., a lunch restaurant may be filtered/removed based upon the lunch restaurant closing before the user gets out of a meeting), a current mode of transportation (e.g., a location of a water fountain may be provided to the user based upon the user being on a run), a current activity of the user or an activity to be performed by the user (e.g., an activity app may display vacation activities when the user is on vacation or local activities that do not start until the user returns from vacation), a current context with which the user is engaged with the user (e.g., music content may be filtered/removed by a shopping app based upon the user having a hearing impaired setting enabled on the device). In another example, the user personalization profile may be generated based upon user data, such as an email, a document (e.g., school documents may be used to determine that the user is in school, which may be used to filter content that may be irrelevant to students), a folder name, a receipt, an installed app, a purchased app, a social network profile, a subscription to a service (e.g., content may be filtered based upon the user having or not having a subscription to a service that provides such content), an association with a business, a coupon, a search history, a calendar, a social network post (e.g., content may be filtered based upon the user expressing a disinterest in such content), an image, etc. In this way, the user personalization profile may be generated for locally filtering of content on the device.

At 104, a set of content candidates retrieved by the device from a remote source (e.g., a second device different than the device, such as a content server or a search engine) may be identified. In an example, coarse filtering may have been performed by the remote source to create the set of content candidates (e.g., restaurant candidates may be reduced to Asian restaurants in downtown Seattle by the remote source without accessing private information of the user). Coarse filtering may reduce the number of content candidates within the set of content candidates, which may mitigate bandwidth utilization between the remote source and the device and/or may mitigate storage and/or processing resource utilization by the device. In an example, the set of content candidates may be retrieved, filtered, and/or stored for later use (e.g., personalization recommendations may be stored for later access by the user such as when a recommendation app is launched). In another example, the set of content candidates may be retrieved, filtered, and provided to the user on demand (e.g., responsive to a user submitting a search query, search results may be retrieved, locally filtered, and provided to the user; responsive to a launch of a restaurant app, menu items may be retrieved, locally filtered based upon a diet of the user, and displayed through the restaurant app; etc.). The set of content candidates may correspond to recommendations, search results, goods for sale (e.g., a list of books, clothing, videogames, etc.), services for sale (e.g., catering companies), menu items, movies, music concerts, apps, and/or a wide variety of content that may be provided to the user (e.g., through a website, an app, an alert, an email, a calendar entry, a recommendation, etc.).

At 106, the user personalization profile associated with the user may be identified. For example, the user personalization profile may be locally stored on the device for local filtering of content. At 108, the set of content candidates may be locally filtered on the device based upon the user personalization profile to generate a filtered set of content. For example, the user personalization profile may indicate that the user is planning an upcoming Bar Mitzvah based upon calendar information (e.g., a calendar entry to start planning for child's once in a lifetime party), an association with a business (e.g., the user may work for a Jewish community school), a social network post about the upcoming party, and/or a variety of other information. Accordingly, catering companies, within the set of content candidates, may be filtered to catering companies that provide Kosher food and/or handle Bar Mitzvahs. In an example of the local filtering, offline filtering may be performed when the device is not connected to the remote source (e.g., a remote entertainment server that provides catering, party planning, and/or a variety of other entertainment content to websites and/or apps such as a party planning app on the device) and/or a network. In another example of the local filtering, the filtering may be performed on the device when the device is connected to the remote source and/or the network. During offline filtering on the device, one or more local filtering operations may be performed on a locally cached set of data, which may mitigate bandwidth utilization that may otherwise occur from repeated queries from the device to a remote device, server, etc. (e.g., a single set of server data may be fetched and locally cached for multiple subsequent queries, such as a long sequence of fine grained drill down queries on the client to the locally cached set of data). In this way, online and/or offline filtering may be locally performed on the device.

The filtered set of content may be presented through the device. In an example, a recommendation of filtered catering companies may be provided. The recommendation may be stored for later retrieval based upon a store input. The recommendation may be shared with one or more users (e.g., through a social network) based upon a share input. A purchase action for a catering company catering plan may be facilitated based upon a purchase input. A reservation for a catering company service may be reserved based upon reservation input. In another example, a map app may be populated with the filtered catering companies. In another example, the filtered catering companies may be displayed through a search engine results page.

Additional filtering capabilities may be dynamically supported on the device. For example, a new filtering module available for filtering content may be identified (e.g., a module repository may advertise new filtering module to the device). Accordingly, a new filtering install module may be retrieved for the new filtering module. The new filtering module may be deployed to the device utilizing the new filtering install module. For example, the new filtering module may be used to filter videogames (e.g., for display through a shopping app) based upon which videogame consoles are owned by the user and/or other considerations of the user. In this way, the user personalization profile and/or the new filtering module may be used to locally filter a second set of content candidates to generate a second filtered set of content (e.g., videogames playable on videogame consoles owned by the user). In this way, content may be locally filtered on the device to mitigate exposure of private user information, offload processing by remote sources, and/or facilitate offline filtering. At 110, the method ends.

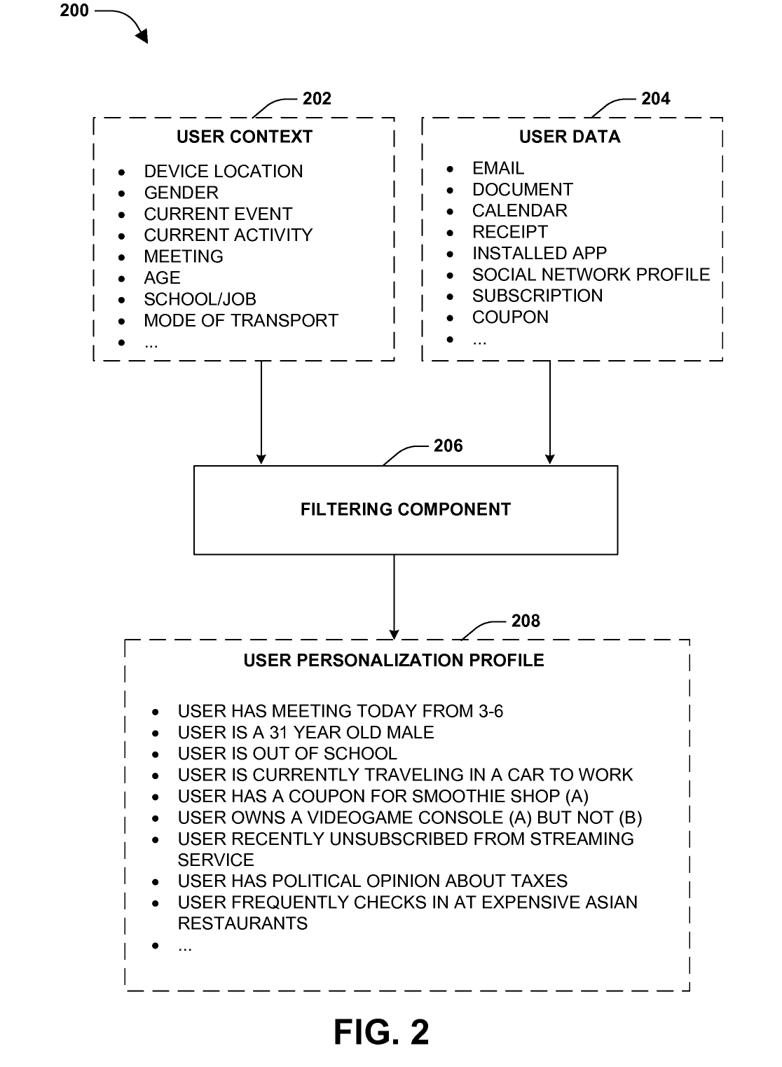

FIG. 2 illustrates an example of a system 200 for generating a user personalization profile 208. The system 200 may comprise a filtering component 206. The filtering component 206 may be associated with a device of a user. The filtering component 206 may be configured to identify a user context 202 associated with the user, such as a device location, a gender of the user, a current event attended or to be attended by the user, a current activity with which the user is currently or will be participating in, a meeting attended or to be attended by the user, an age of the user, whether the user is in school, whether the user has a job, a mode of transportation of the user, etc. The filtering component 206 may be configured to identify user data 204 associated with the user, such as an email, a document, a calendar, a receipt, an installed app, a social network profile, a subscription, a coupon, etc.

The filtering component 206 may be configured to generate the user personalization profile 208 based upon the user context 202 and/or the user data 204. For example, the user personalization profile 208 may indicate that the user has a meeting today from 3-6, that the user is a 31 year old male that is out of school, that the user is traveling in a car to work, that the user has a coupon for a Smoothie Shop (A), that the user owns a Videogame Console (A) but not a Videogame Console (B), that the user recently unsubscribed from a streaming service, that the user has a political opinion about taxes, that the user frequently checks in at expensive Asian restaurants, and/or other personalization information about the user. The filtering component 206 may maintain the user personalization profile 208 on the device of the user for local filtering of content. Local filtering of content may maintain, promote, improve, etc. privacy of personalization information of the user because such information is not sent to other devices.

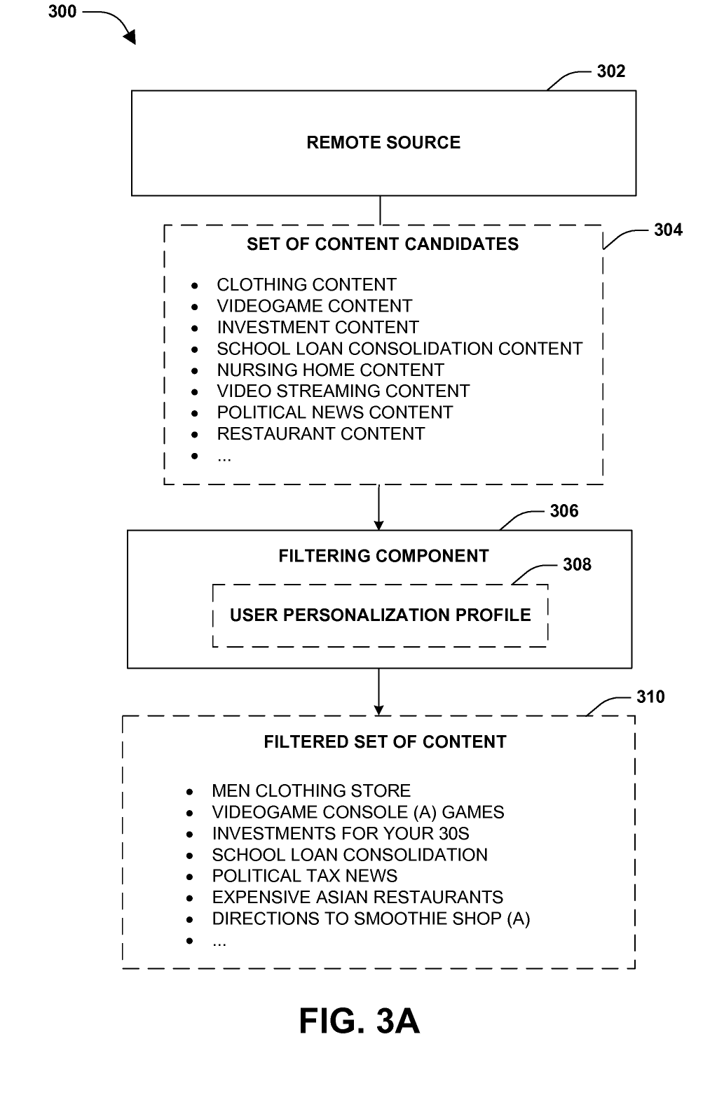

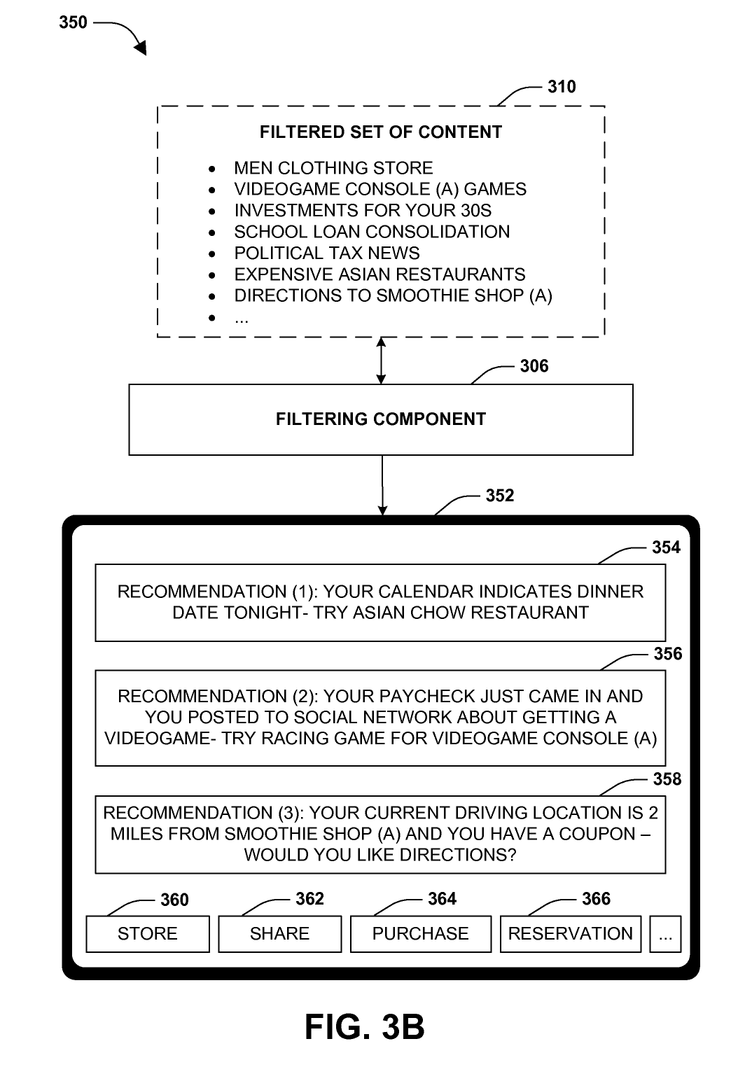

FIG. 3A illustrates an example of a system 300 for locally filtering a set of content candidates 304 for storage as a filtered set of content 310. The system 300 comprises a filtering component 306. The filtering component 306 may be configured to identify a user personalization profile 308 indicative of personal information about a user of a device (e.g., 208 of FIG. 2). The filtering component 306 may be configured to identify the set of content candidates 304 retrieved by the device from a remote source 302. For example, the set of content candidates 304 may corresponds to various content that may be provided, such as recommendations, to the user through the device (e.g., recommendations for clothing, videogames, investments, school loan consolidations, nursing homes, video streaming, political news, restaurants, and/or a variety of other content that may be recommended to the user).

The filtering component 306 may utilize the user personalization profile 308 to filter the set of content candidates 304 to create the filtered set of content 310 that may be relevant and/or useful to the user (e.g., irrelevant, unhelpful, and/or uninteresting content such as the nursing home content may be filtered/removed). For example, the filtered set of content 310 may comprise men's clothing (e.g., based upon the user being a 31 year old male), Videogame Console (A) games (e.g., based upon the user owning the Videogame Console (A)), investments for people in their 30s (e.g., based upon the user being 31), school loan consolidations (e.g., based upon the user being 31 and out of school, which might indicate the user has school loans), political tax news (e.g., based upon the user having a political opinion about taxes), expensive Asian restaurants (e.g., based upon the user frequently checking in at expensive Asian restaurants), directions to a Smoothie Shop (A) (e.g., based upon the user having a coupon to the Smoothie Shop (A)), etc. Other less relevant content within the set of content candidates, such as the nursing home content, may be filter/removed. In this way, the filtered set of content 310 may be stored and/or provided through the device to the user (e.g., FIG. 3B).

FIG. 3B illustrates an example of a system 350 for providing recommendations through a device 352 based upon a filtered set of content 310. The system 350 comprises a filtering component 306. In an example, the filtering component 306 may have filtered a set of content candidates retrieved by the device 352 from a remote source to create the filtered set of content 310 (e.g., FIG. 3A). The filtering component 306 may provide a first recommendation 354 specifying that the user's calendar indicates a dinner date tonight and thus the user should try an Asian Chow Restaurant (e.g., based upon the user frequently checking in to expensive Asian restaurants). The filtering component 306 may provide a second recommendation 356 specifying that the user's paycheck just came in and that the user posted to a social network about getting a videogame, and thus the user should try out the Racing Game for the Videogame Console (A) (e.g., based upon the user owning the Videogame Console (A)). The filtering component 306 may provide a third recommendation 358 specifying that the user's current driving location is 2 miles away from a Smoothie Shop (A) and that the user has a coupon to the Smoothie Shop (A), and thus directions may be offered to the user.

Various functionality for recommendations may be facilitated. For example, responsive to receiving store input 360, a recommendation may be stored on the device 352 for later retrieval. Responsive to receiving share input 362, a recommendation may be shared with a second user (e.g., emailed to the second user, shared through a social network post, etc.). Responsive to receiving purchase input 364, a good and/or service recommended by a recommendation may be purchased. Responsive to receiving reservation input 366, a reservation associated with a good (e.g., reservation of an upcoming videogame) and/or a service (e.g., reserving a seat at a restaurant) recommend by a recommendation may be reserved.

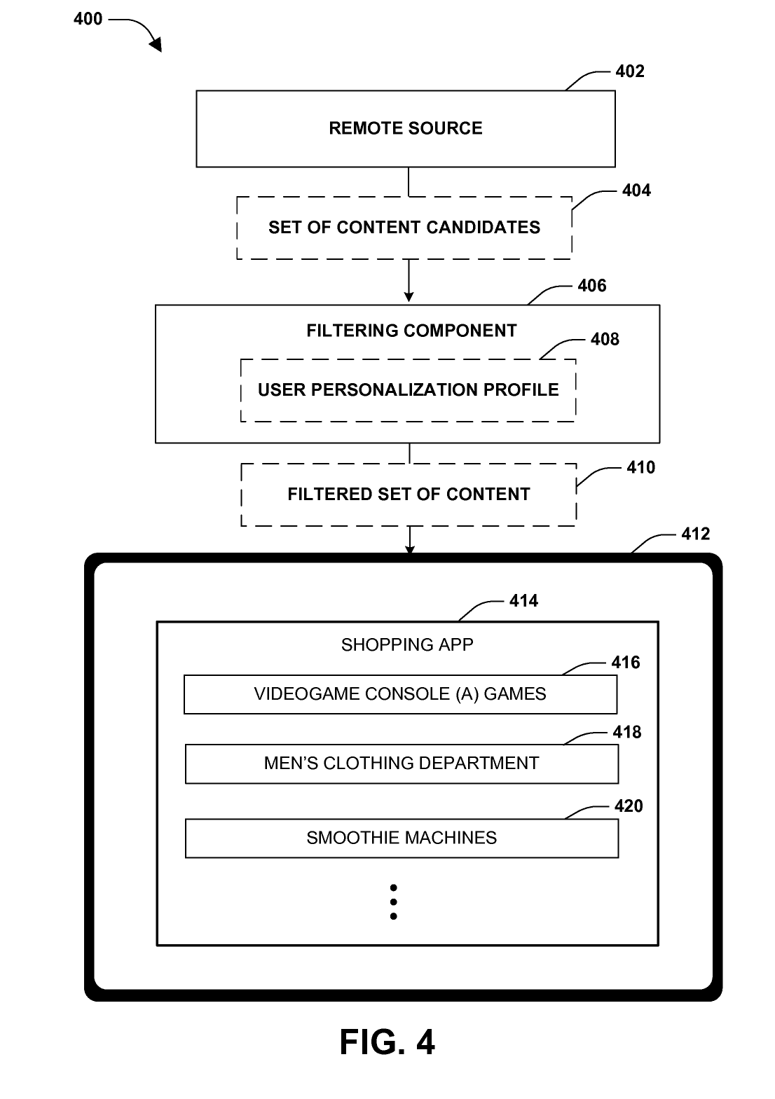

FIG. 4 illustrates an example of a system 400 for providing locally filtered content. The system 400 may comprise a filtering component 406 associated with a device 412 of a user. The filtering component 406 may identify a set of content candidates 404 (e.g., merchandise for sale) retrieved by a shopping app 414 on the device 412 from a remote source 402 (e.g., a shopping server). The filtering component 406 may identify a user personalization profile 408 associated with the user. The filtering component 406 may locally filter, on the device 412, the set of content candidates 404 to generate a filtered set of content 410. The filtered set of content 410 may be provided to the shopping app 414 so that merchandise relevant to the user may be presented by the shopping app 414. For example, Videogame Console (A) games 416 may be provided based upon the user owning a Videogame Console (A), a merchandise of a men's clothing department 418 may be provided based upon the user being a 31 year old male, smoothie machines 420 may be provided based upon the user having a coupon to a Smoothie Shop (A).

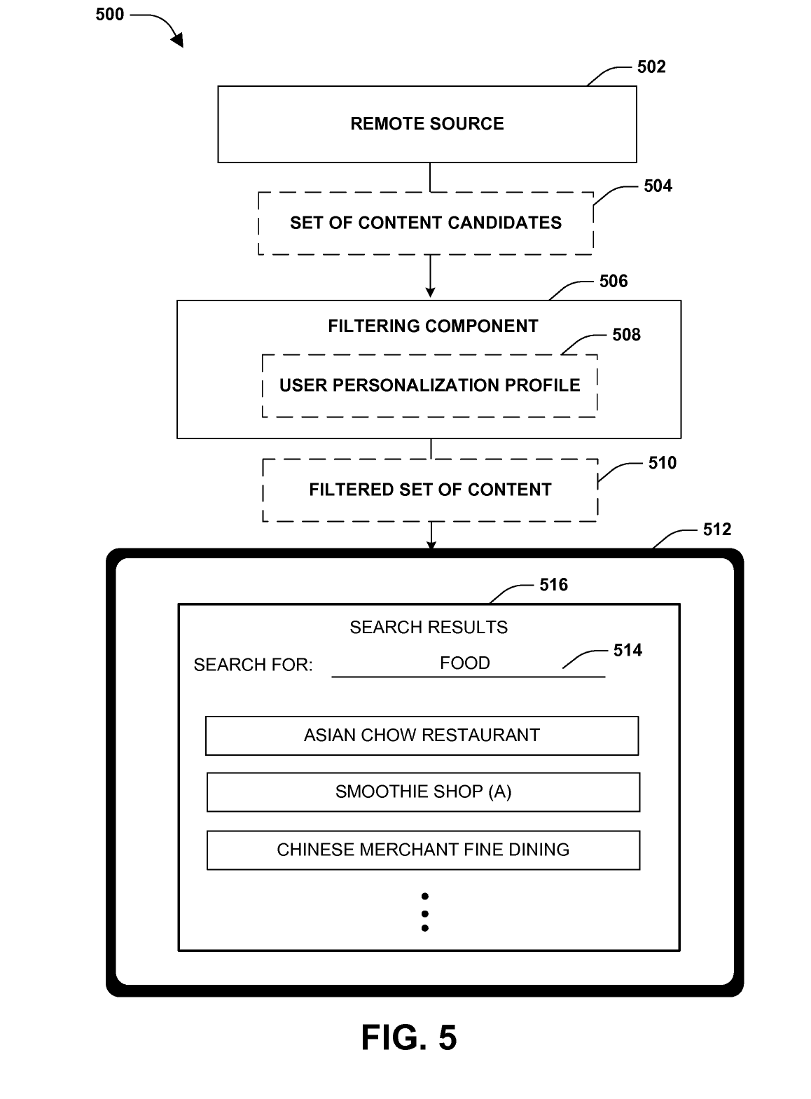

FIG. 5 illustrates an example of a system 500 for providing locally filtered content. The system 500 may comprise a filtering component 506 associated with a device 512 of a user. The filtering component 506 may identify a set of content candidates 504 (e.g., search results corresponding a search query 514 “food”) retrieved by a web browser on the device 512 from a remote source 502 (e.g., a search engine that hosts a search website through which the query 514 “food” was received). The filtering component 506 may identify a user personalization profile 508 associated with the user. The filtering component 506 may locally filter, on the device 512, the set of content candidates 504 to generate a filtered set of content 510. The filtered set of content 510 may be provided through a search engine results interface 516 displayed through the web browser of the device 512. For example, an Asian Chow Restaurant search result and a Chinese Merchant Fine Dining search result may be provided based upon the user frequently checking in at expensive Asian restaurants. A Smoothie Shop (A) search result may be provided based upon the user having a Smoothie Shop (A) coupon.

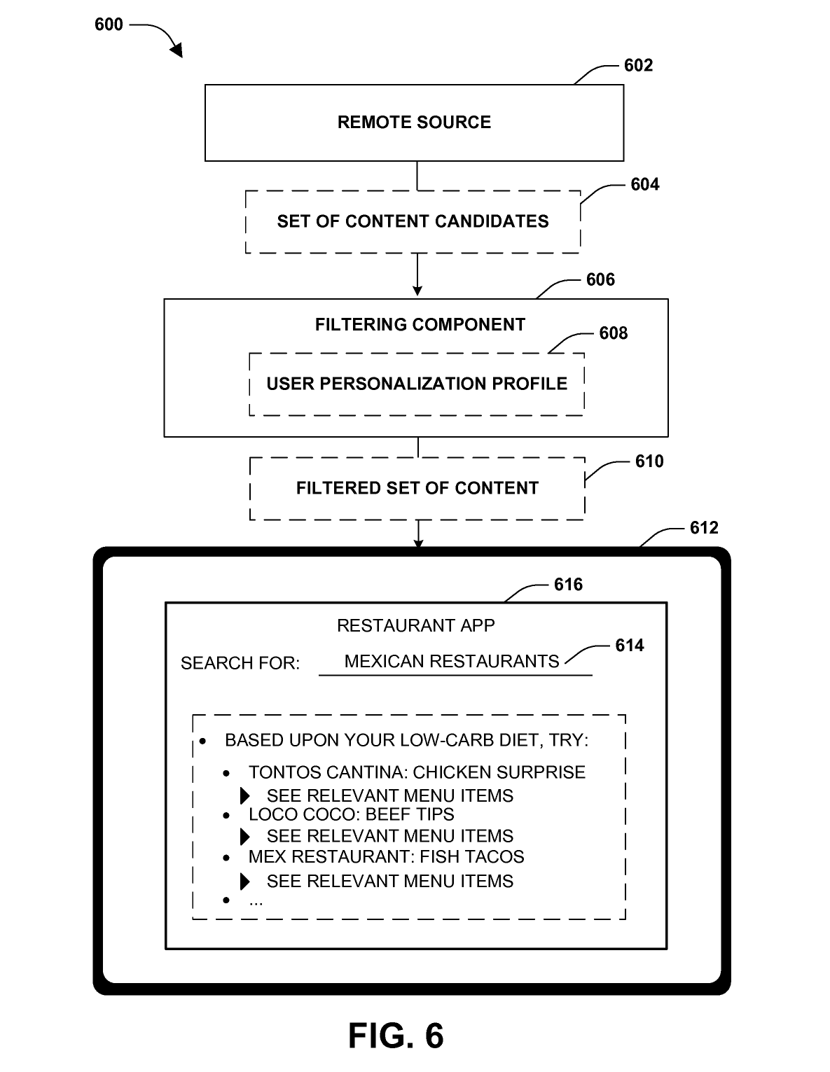

FIG. 6 illustrates an example of a system 600 for providing locally filtered content. The system 600 may comprise a filtering component 606 associated with a device 612 of a user. The filtering component 606 may identify a set of content candidates 604 retrieved by a restaurant app 616 on the device 612 from a remote source 602 (e.g., a restaurant server may provide restaurant search results based upon a search query 614 “Mexican restaurants” submitted through the restaurant app 616 hosted on the device 612). The filtering component 606 may identify a user personalization profile 608 associated with the user. The filtering component 606 may locally filter, on the device 612, the set of content candidates 604 to generate a filtered set of content 610. The filtered set of content 610 may be provided to the restaurant app 616 so that restaurant search results relevant to the user may be presented by the restaurant app 616 (e.g., irrelevant and/or uninteresting restaurant search results may be filtered/removed). For example, various Mexican restaurants that provide low-carb dishes and/or low-carb menu items may be provided through the restaurant app 616 based upon the user being on a low-carb diet.

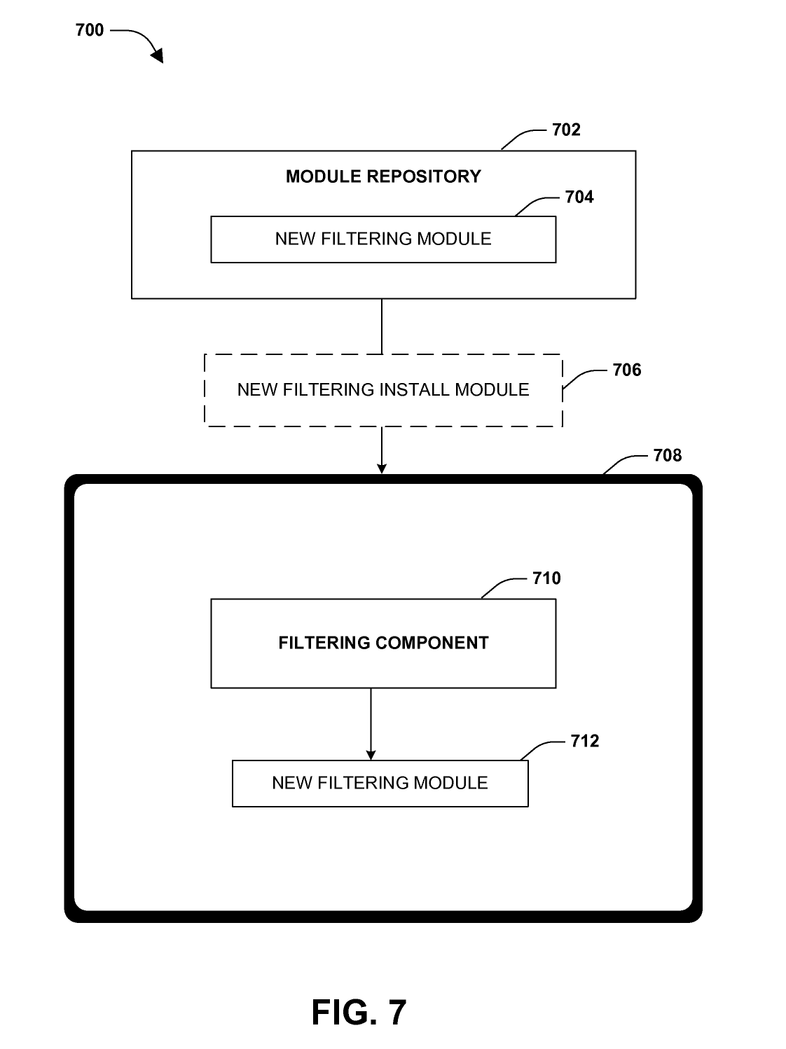

FIG. 7 illustrates an example of a system 700 for adding filtering functionality to a device 708. The system 700 may comprise a filtering component 710 associated with a device 708. The filtering component 710 may be configured to locally filter content on the device 708. In an example, the filtering component 710 may identify a new filtering module 704 available for filtering content. For example, the new filtering module 704 may be available through a module repository 702 that is remote to the device 708. The filtering component 710 may retrieve a new filtering install module 706 from the module repository 702. The filtering component 710 may install the new filtering module 712 on the device 708 utilizing the new filtering install module 706. In this way, new filtering functionality may be dynamically added to the device (e.g., the new filtering module 712 may filter social network content to home renovation ideas based upon identifying a current home renovation project associated with a user).

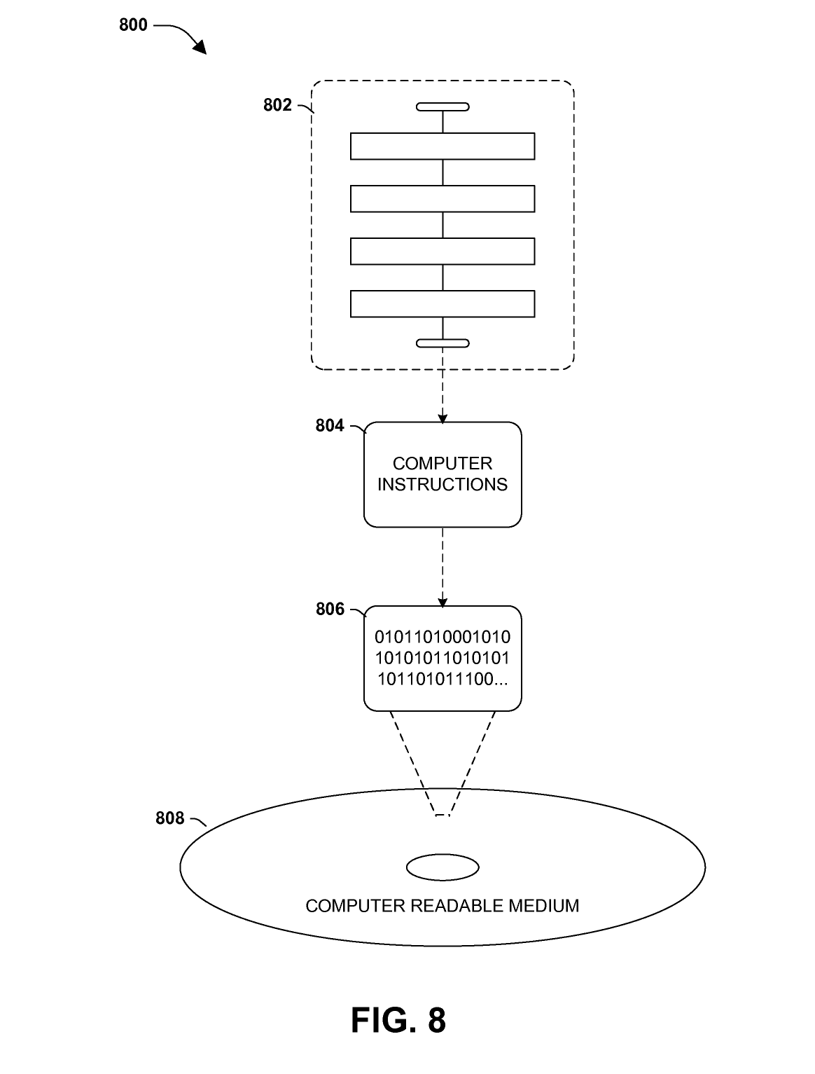

Still another embodiment involves a computer-readable medium comprising processor-executable instructions configured to implement one or more of the techniques presented herein. An example embodiment of a computer-readable medium or a computer-readable device is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 100 of FIG. 1, for example. In some embodiments, the processor-executable instructions 804 are configured to implement a system, such as at least some of the exemplary system 200 of FIG. 2, at least some of the exemplary system 300 of FIG. 3A, at least some of the exemplary system 350 of FIG. 3B, at least some of the exemplary system 400 of FIG. 4, at least some of the exemplary system 500 of FIG. 5, at least some of the exemplary system 600 of FIG. 6, and/or at least some of the exemplary system 700 of FIG. 7, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

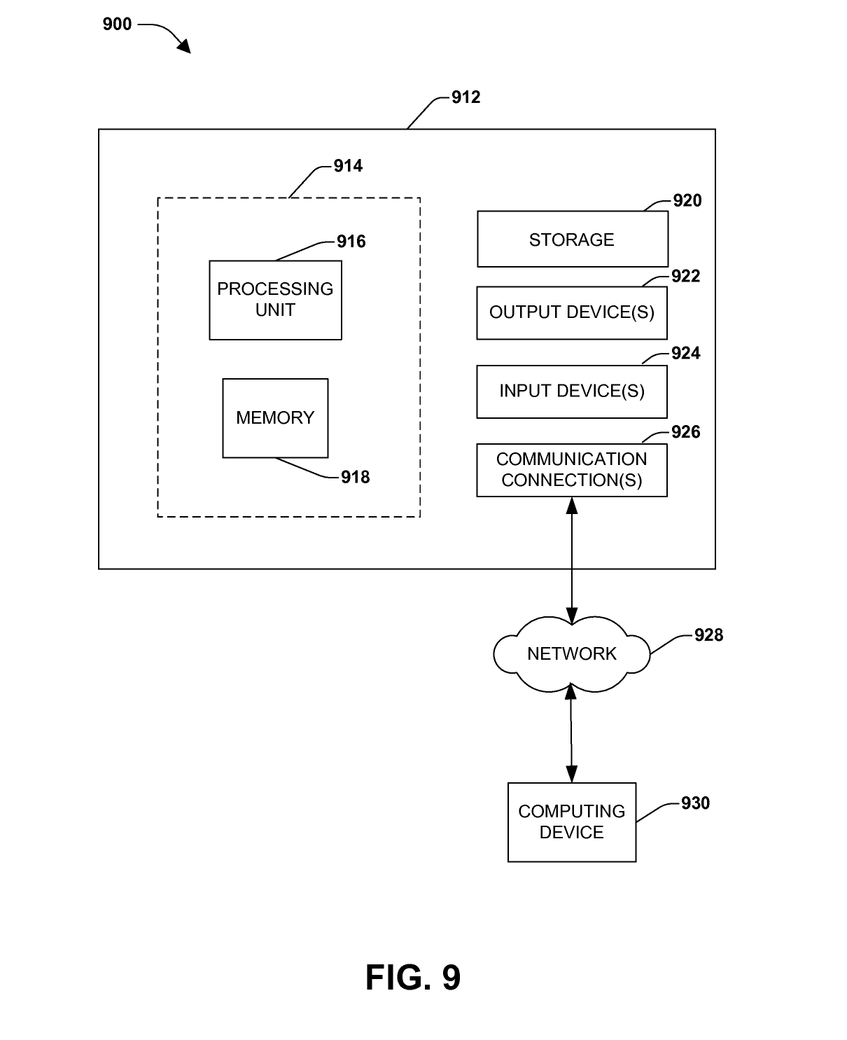

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for local filtering of content, comprising:
identifying a set of content candidates retrieved by a device, associated with a user, from a remote source;
identifying a user personalization profile associated with the user; and
locally filtering, on the device, the set of content candidates based upon the user personalization profile to generate a filtered set of content.

2. The method of claim 1, comprising:
generating the user personalization profile based upon a user context.

3. The method of claim 2, the user context corresponding to at least one of a device location, a gender, a current event attended by the user, a meeting attended by the user, a current mode of transportation, a current activity of the user, or a current context with which the user is engaged with the device.

4. The method of claim 1, comprising:
generating the user personalization profile based upon user data.

5. The method of claim 4, the user data corresponding to at least one of an email, a document, a folder name, a receipt, an installed app, a purchased app, a social network profile, a subscription to a service, an association with a business, a coupon, a search history, a calendar, a social network post, or an image.

6. The method of claim 1, comprising:
presenting the filtered set of content through the device.

7. The method of claim 6, the presenting comprising:
displaying a recommendation.

8. The method of claim 7, comprising at least one of:
responsive to receiving a store input associated with the recommendation, storing the recommendation to the device for later retrieval;
responsive to receiving a share input associated with the recommendation, sharing the recommendation with a second user;
responsive to receiving a purchase input associated with the recommendation, facilitating a purchase action for at least one of a good or a service recommended by the recommendation; or
responsive to receiving a reservation input associated with the recommendation, facilitating a reservation associated with at least one of the good or the service recommended by the recommendation.

9. The method of claim 1, the filtered set of content comprising at least one of a recommendation, a search result, a good for sale, a service for sale, a menu item, a movie, a music concert, or an app.

10. The method of claim 1, the locally filtering comprising:
performing offline filtering when the device is not connected to at least one of the remote source or a network.

11. The method of claim 1, the locally filtering comprising:
performing filtering when the device is connected to at least one of the remote source or a network.

12. The method of claim 1, comprising:
responsive to identifying a new filtering module available for filtering content:
retrieving a new filtering install module for the new filtering module; and
deploying the new filtering module to the device utilizing the new filtering install module.

13. The method of claim 12, comprising:
identifying a second set of content candidates from a second remote source; and
locally filtering, on the device, the second set of content candidates based upon the user personalization profile and the new filtering module to generate a second filtered set of content.

14. The method of claim 1, the locally filtering comprising:
filtering the set of content candidates on demand in response to a launch of an app that consumes the set of content candidates.

15. The method of claim 1, comprising:
storing the filtered set of content on the device; and
responsive to a launch of an app that consumes the filtered set of content, providing the filtered set of content to the app.

16. A system for local filtering of content, comprising:
a filtering component configured to:
identify a set of content candidates retrieved by a device, associated with a user, from a remote source;
identify a user personalization profile associated with the user; and
locally filter, on the device, the set of content candidates based upon the user personalization profile to generate a filtered set of content.

17. The system of claim 16, the filtering component configured to:
perform filtering regardless of whether the device is connected to a network.

18. The system of claim 16, the filtered set of content comprising at least one of a recommendation, a search result, a good for sale, a service for sale, a menu item, a movie, a music concert, or an app.

19. A computer readable medium comprising instructions which when executed perform a method for local filtering of content, comprising:
identifying a set of content candidates retrieved by a device, associated with a user, from a remote source;
identifying a user personalization profile associated with the user; and
locally filtering, on the device, the set of content candidates based upon the user personalization profile to generate a filtered set of content.

20. The computer readable medium of claim 19, comprising:
performing offline filtering when the device is not connected to at least one of the remote source or a network.
